(19) United States
(12) Patent Application Publication
(10) Pub. No.: US 2006/0066282 A1
(43) Pub. Date: Mar. 30, 2006

(54) Motor apparatus and optical scanning apparatus, each with feedback control of drive load

(75) Inventor: Yasuhiro Soeda, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/222,854

(22) Filed: Sep. 12, 2005

(30) Foreign Application Priority Data
Sep. 15, 2004 (JP) 2004-268858

(51) Int. Cl. G05B 19/40

(52) U.S. Cl. 318/685

(57) ABSTRACT

A motor apparatus has a motor which is rotatable by electromagnetic force, a load mounted to an output shaft of the motor, and an angular detecting unit for detecting a rotational angle of the output shaft of the motor or the load. In the motor apparatus, the angular detecting unit has a magnetic sensor and a magnet, and one of the magnetic sensor and the magnet is fixed to the output shaft of the motor or to the rotational axis portion of the load on a side opposite to a side of the motor with the load interposed therebetween.

### BACKGROUND OF THE INVENTION

1. Field of the Invention

The present invention relates to a motor apparatus, and an optical scanning apparatus using the motor apparatus.

2. Description of the Related Background Art

With a motor apparatus for driving a drive object by a motor that is rotated or swung with an electromagnetic force, feedback control is typically carried out so that the position, the speed, and other parameters of a drive load (the drive object) can be accurately controlled. In the feedback control, when the position of the drive object is fed back, the feedback is performed in a system from the motor to the drive object, involving characteristics of the backlash of a gear, for example. As a result, the drive object can be controlled with accuracy. However, a detecting unit for detecting the position must cover the entire moving range of the drive object, and the cost of the detecting unit is hence likely to increase.

On the other hand, when the feedback control is carried out by detecting the rotational angle of an output shaft of the motor, the feedback control does not require all of the above-discussed characteristics. Therefore, although the characteristics need to be compensated for by feed-forward, a position detecting unit used therein can be advantageously constructed at reduced cost. Further, in a case where the drive object is mounted to the output shaft of the motor and directly driven without intermediate means, such as the gear, feedback control is carried out by detecting the rotational angle of the output shaft of the motor.

When the detecting unit for detecting the rotational angle of the output shaft of the motor is constructed by using a magnetic sensor, it can be obtained at a reduced cost. In a case where the magnetic sensor is used to detect the rotational angle of a motor that is driven by electromagnetic force, however, an error is likely to occur in the detection of the rotational angle since unwanted magnetic fields other than the magnetic field representing the rotational angle also act on the magnetic sensor. In order to solve this disadvantage, Japanese Patent No. 3172586 proposes a magnetic position sensor in which a magnetic field eliminating coil is provided so that any magnetic field other than the magnetic field representing the rotational angle cannot act on the magnetic sensor.

In the above structure provided with the unit for eliminating magnetic fields other than the magnetic field representing the rotational angle, the magnetic field of the coil should be accurately regulated. Further, the coil is located close to the magnetic sensor to eliminate the magnetic field only locally, so that influence of the coil on the electromagnetic force of the motor can be prevented. However, due to such a location, current flowing in the coil is likely to sensitively act on the magnetic sensor. It is hence difficult to accurately regulate the magnetic field of the coil.

### SUMMARY OF THE INVENTION

It is an object of the present invention to provide techniques for solving the above disadvantage.

According to one aspect of the present invention, there is provided a motor apparatus including a motor with an output shaft, that is capable of being rotated by electromagnetic force; a load with a rotational axis portion, that is mounted to the output shaft of the motor; and an angular detecting unit for detecting a rotational angle of the output shaft of the motor or the load. In the motor apparatus, the angular detecting unit includes a magnetic sensor and a magnet, and one of the magnetic sensor and the magnet is fixed to the output shaft of the motor, or the rotational axis portion of the load on a side opposite to a side of the motor with the load interposed therebetween.

According to another aspect of the present invention, there is provided an optical scanning apparatus wherein there is provided a motor apparatus as described above, in which the load is an optical reflective mirror, and wherein light from a light source is scanned by the optical reflective mirror.

In the construction of a motor apparatus of the present invention wherein one of the magnetic sensor and the magnet is fixed to the output shaft of the motor, or the rotational axis portion of the load on the side opposite to the side of the motor with the load interposed therebetween, it is possible to dispose the magnetic sensor at a location, on which any magnetic field other than the magnetic field representing the rotational angle of the output shaft of the motor, or the rotational axis portion of the load almost cannot act, since the intensity of magnetic field rapidly decreases in inverse proportion to a distance. Therefore, there is no need to provide a unit for eliminating the magnetic field, which was needed in a conventional apparatus. Further, there is no need to accurately regulate the magnetic field of the coil, which was also needed in a conventional apparatus. Thus, it becomes possible to make the construction of the present invention relatively simple.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrates embodiments of the invention and, together with the description, serve to explain the principles of the invention.

FIG. 1 is a perspective view illustrating an embodiment of a motor apparatus according to the present invention.

FIG. 2 is a perspective view illustrating an embodiment of an optical scanning apparatus according to the present invention.

### DETAILED DESCRIPTION OF THE PREFERRED EMBODIMENTS

A description will be now given for embodiments of the present invention with reference to the drawings.

In an embodiment of a motor apparatus according to the present invention, the motor apparatus includes a motor, such as a step motor, capable of being rotated by electromagnetic force, a load mounted to an output shaft of the motor, and an angular detecting unit for detecting the rotational angle of the output shaft of the motor or the load. In the motor apparatus, the angular detecting unit includes a magnetic sensor, such as a sensor that uses Hall effect, and a magnet, and one of the magnetic sensor and the magnet is fixed to the output shaft of the motor or to a rotational axis portion of the load on a side opposite to a side of the motor with the load interposed therebetween.

Either the magnetic sensor or the magnet can be fixed to the output shaft of the motor or the rotational axis portion of the load, because it is only required for magnetic field from the magnet to change at a location of the magnetic sensor in accordance with a change in a relative positional relationship between the magnetic sensor and the magnet caused by the rotation. However, a detection signal can be pulled out in a simpler manner when the magnet is fixed to a moving side and the magnetic sensor is arranged on a stationary side than when these are disposed oppositely. When one of the magnetic sensor and the magnet is fixed to the output shaft of the motor, the rotational angle of the output shaft of the motor can be detected by the angular detecting unit. In such a structure, position, speed, and the like of the load, such as an optical reflective mirror, a gear, a pulley, and a cam, can be feedback controlled, using the detection result.

When one of the magnetic sensor and the magnet is fixed to the rotational axis portion of the load, the rotational angle of the rotational axis portion of the load can be detected by the angular detecting unit. Also in such a structure, position, speed, and other load parameters can be feedback controlled, using the detection result similarly. As the magnetic sensor, a coil, or a winding for detecting a change in magnetic field by using electromagnetic induction can also be employed, as well as a sensor that uses Hall effect.

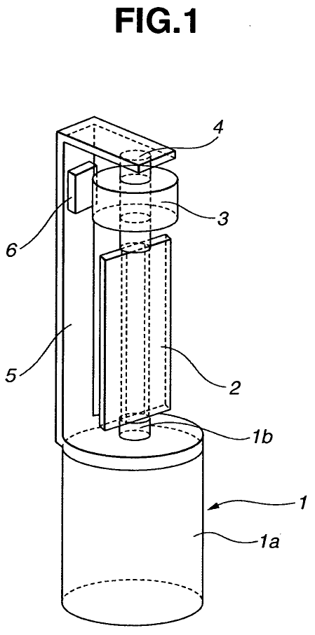

A more specific construction of the embodiment will be described with reference to FIG. 1. As illustrated in FIG. 1, the embodiment of the motor apparatus is comprised of a motor 1, a reflective mirror 2, a magnet 3, a bearing 4, a support member 5, and a magnetic sensor 6. The motor 1 includes a stator 1a and a rotational shaft 1b. The motor 1 is an electric motor in which the rotational shaft 1b is rotated relative to the stator 1a by electromagnetic force. The reflective mirror 2 is fixed to the rotational shaft 1b, and rotated together with the rotational shaft 1b. The magnet 3 is fixed to the rotational shaft 1b on a side opposite to a side of the stator 1a with the reflective mirror 2 interposed therebetween. The magnet 3 is rotated together with the rotational shaft 1b and the reflective mirror 2. The bearing 4 rotatably supports an end portion of the rotational shaft 1b at the end opposite to the end on which the stator 1a is provided.

The support member 5 serves to fix the bearing 4 so that the bearing 4 cannot be displaced relative to the stator 1a of the motor 1. In other words, the end portion of the output shaft 1b of the motor 1 is rotatably supported by the bearing 4 that is fixed without any positional change relative to the stator 1a of the motor 1.

The magnetic sensor 6 is fixed to the support member 5, and serves to convert the intensity of magnetic field into an electrical signal. The magnetic sensor 6 is a device using Hall effect, for example. In the structure illustrated in FIG. 1, a scan mirror, or the optical reflective mirror 2 is driven by the motor 1, and rotated together with the rotational shaft 1b. Thus, light incident on the scan mirror 2 is deflected in a desired angular direction, and scanned. The angle of the reflective mirror 2 is detected by the magnetic sensor 6. The magnetic sensor 6 detects a changing condition of the magnetic field from the magnet 3 that is rotating together with the scan mirror 2.

In this embodiment, the magnet 3 is fixed to the rotational shaft 1b of the motor 1 on the side opposite to the side of the motor 1 with the reflective mirror 2 interposed therebetween. Further, the magnetic sensor 6 is provided on a fixed side near the magnet 3. Thus, the magnetic sensor is disposed at a location on which there is little effect from any magnetic field other than the magnetic field representing the rotational angle of the output shaft 1b of the motor 1. Accordingly, the rotational angle, position, and the like of the output shaft 1b of the motor 1 can be accurately detected, and an accurate feedback control can be executed.

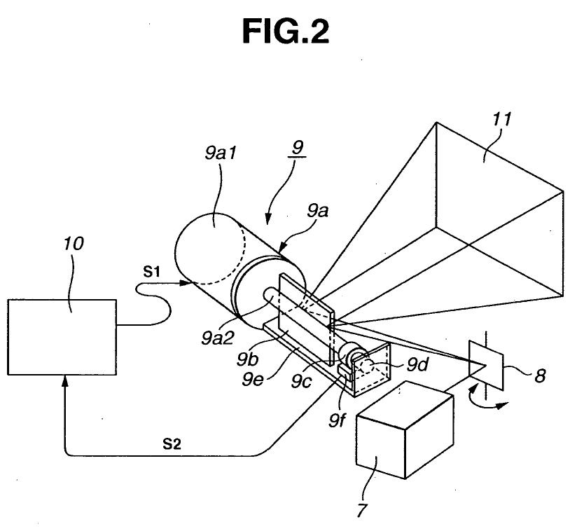

FIG. 2 illustrates an embodiment of an optical scanning apparatus according to the present invention. In a construction illustrated in FIG. 2, the embodiment of a scanning apparatus as illustrated in FIG. 1 is used as a vertical scanning device in a laser display wherein laser light is scanned in horizontal and vertical directions to form an image. In FIG. 2, the embodiment of the laser display is comprised of a laser 7, a horizontal scanning device 8, a vertical scanning device 9, a driver 10, and a screen 11. The vertical scanning device 9 includes a motor 9a, a reflective mirror 9b, a magnet 9c, a bearing 9d, a support member 9e, and a magnetic sensor 9f. The motor 9a includes a stator 9a1 and a rotational shaft 9a2. The laser serves as a light source. The horizontal scanning device 8 serves to scan the laser light in the horizontal direction.

The vertical scanning device 9 has a construction similar to that of the scanning apparatus illustrated in FIG. 1. The motor 9a, stator 9a1, rotational shaft 9a2, reflective mirror 9b, magnet 9c, bearing 9d, support member 9e, and magnetic sensor 9f correspond to the motor 1, stator 1a, rotational shaft 1b, reflective mirror 2, magnet 3, bearing 4, support member 5, and magnetic sensor 6, respectively. When the motor 9a is a two-phase PM type step motor, its cost and size can be advantageously reduced. With the two-phase PM type step motor, the shape of its stator is simple as compared with those of step motors of three or more phases, and the shape of its rotor is simple as compared with those of step motors of VR (variable reluctance) type, and HB (hybrid) type.

In the operation of this embodiment, the vertical scanning device 9 supplies a signal S2 from the magnetic sensor 9f, that is a signal identifying the rotational angle of the reflective mirror 9b. The driver 10 receives the signal S2. Based on the signal S2, the driver 10 rotates and drives the motor 9a via a signal S1 in a feedback control manner. In this construction, the laser 7 is modulated and driven by an image signal from an external device, and emits light. The light enters the horizontal scanning device 8, and is horizontally scanned thereby. Then, the light enters the vertical scanning device 9, and is vertically scanned thereby. The light is thus two-dimensionally scanned in both horizontal and vertical directions, and forms an image on the screen 11. Here, the reflective mirror 9b in the vertical scanning device 9 is accurately rotated and controlled, so that the light can be accurately scanned. Therefore, a high-quality image can be formed on the screen 11.

As many apparently widely different embodiments of the present invention can be made without departing from the spirit and scope thereof, it is to be understood that the invention is not limited to the specific embodiments thereof except as defined in the claims.

This application claims priority from Japanese Patent Application No. 2004-268858, filed Sep. 15, 2004, the contents of which are hereby incorporated by reference.

What is claimed is:

1. A motor apparatus comprising:
a motor with an output shaft, the motor being rotatable by electromagnetic force;
a load with a rotational axis portion, the load being mounted to the output shaft of the motor; and
angular detecting means for detecting a rotational angle of the output shaft or the load,
wherein the angular detecting means includes a magnetic sensor and a magnet, and one of the magnetic sensor and the magnet is fixed to the output shaft or to the rotational axis portion of the load on a side opposite to a side of the motor with the load interposed therebetween.

2. A motor apparatus according to claim 1, wherein a tip portion of the output shaft is rotatably supported by a bearing, the bearing being provided in such a fixed manner that no positional change of the bearing relative to the stator of the motor occurs.

3. A motor apparatus according to claim 1, wherein the magnetic sensor is one of a sensor that uses Hall effect, and a winding that detects a change in magnetic field using electromagnetic induction.

4. A motor apparatus according to claim 1, wherein the motor is a step motor.

5. An optical scanning apparatus comprising:
a motor with an output shaft, the motor being rotatable by electromagnetic force;
an optical reflective mirror with a rotational axis portion, the optical reflective mirror being mounted to the output shaft of the motor; and
angular detecting means for detecting a rotational angle of the output shaft or the optical reflective mirror,
wherein the angular detecting means includes a magnetic sensor and a magnet, and one of the magnetic sensor and the magnet is fixed to the output shaft or to the rotational axis portion of the optical reflective mirror on a side opposite to a side of the motor with the optical reflective mirror interposed therebetween,
wherein light from a light source is scanned by the optical reflective mirror.
